(19) United States
(12) Patent Application Publication
(10) Pub. No.: US 2008/0225449 A1
(43) Pub. Date: Sep. 18, 2008

(54) ELECTROSTATIC DISCHARGE PROTECTION COMPONENT, AND ELECTRONIC COMPONENT MODULE USING THE SAME

(76) Inventors: Tatsuya INOUE, Osaka (JP); Hidenori KATSUMURA, Hyogo (JP); Masaaki Hayama, Nara (JP)

Correspondence Address: MCDERMOTT WILL & EMERY LLP, 600 13TH STREET, NW, WASHINGTON, DC, 20005-3096, US

(21) Appl. No.: 12/047,494

(22) Filed: Mar. 13, 2008

(30) Foreign Application Priority Data
Mar. 13, 2007 (JP) 2007-063197
Apr. 17, 2007 (JP) 2007-107945

(51) Int. Cl. H02H 9/04; H01C 7/10

(52) U.S. Cl. 361/56; 338/21

(57) ABSTRACT

An electrostatic discharge protection component comprising a ceramic sintered body having ceramic substrate 12, varistor portion 10 formed thereon excluding some non-formed portion 18, and glass ceramic layer 14 further formed thereon, a pair of terminal electrodes 13a, 13b disposed by exposing a part thereof at non-formed portion 18 on ceramic substrate 12 of the ceramic sintered body, a pair of external electrodes 16a, 16b, and heat conducting portion 15 vertically penetrating ceramic substrate 12, a light-emitting diode or the like mounted on heat conducting portion 15 at non-formed portion 18, it is possible to reduce the size and to efficiently dissipate the heat generated by the component mounted.

### BACKGROUND OF THE INVENTION

1. Field of the Invention

The present invention relates to an electrostatic discharge protection component (hereinafter referred to simply as protection component) which protects an electronic device from electrostatic discharge, and an electronic component module using the same such as a light-emitting diode module.

2. Background Art

Recently, electronic equipment such as a mobile phone and the like is rapidly reduced in size and power consumption, and accordingly, the withstand voltages of various types of electronic component which configure the circuit of electronic equipment are becoming lower.

As a result, troubles increasingly occur in electronic equipment due to breakdown of electronic components, semiconductor devices in particular, caused by electrostatic discharge pulses generated when human body comes in contact with a conductive part of electronic equipment.

Also, with the advance of white blue diodes, a light-emitting diode which is a kind of semiconductor device is expected to be widely used for the back light of a display device or the flash of a small camera. However, such a white blue diode is low in the withstand voltage against electrostatic discharge pulses, giving rise to the occurrence of a problem.

A conventional countermeasure against such electrostatic discharge pulses is to provide an electronic component having non-linear resistance characteristic such as varistor and Zener diode between the incoming line of electrostatic discharge and the ground so as to bypass the electrostatic discharge pulse to the ground, thereby reducing the high voltage applied to the light emitting diode.

An example of conventional technology for protecting a light-emitting diode from electrostatic discharge pulses by using a varistor or Zener diode is disclosed in Japanese Patent Unexamined Publication No. 2002-335012.

However, in such a conventional configuration wherein a light-emitting diode is combined with a varistor or Zener diode, the light-emitting diode is just connected to the varistor or Zener diode via another member such as a substrate, which is not integrated and therefore difficult to be reduced in size.

Also, it is necessary to apply greater current in order to enhance the light emission of the light-emitting diode. However, as the current applied becomes greater, the light-emitting diode itself generates heat. And, due to the heat, the light-emitting diode is deteriorated, and it invites such a result that the light emitting efficiency is lowered and the life becomes shorter. Accordingly, in order to prevent lowering of the light emitting efficiency and shortening of the life of the light-emitting diode, it is necessary to efficiently release such heat generated by the light-emitting diode. However, in the case of a chip type which is a relatively small-sized package, it is difficult to efficiently release heat generated by a light-emitting diode because of having no heat dissipation mechanism and using resin for facing.

### SUMMARY OF THE INVENTION

The present invention is intended to solve the above problem, and the object of the invention is to provide a protection component which is small and strong being excellent in heat dissipation, and an electronic component module using the same.

In order to achieve the above purpose, the protection component of the present invention comprises a ceramic sintered body having a ceramic substrate, a varistor portion formed by alternately laminating a varistor layer and an internal electrode on the ceramic substrate, and a glass ceramic layer formed on the varistor portion, a pair of terminal electrodes disposed on the ceramic sintered body, a pair of external electrodes connected to the internal electrode and the terminal electrodes, and a heat conducting portion penetrating the ceramic sintered body, wherein the varistor portion and the glass ceramic layer are formed excluding some non-formed portion of the ceramic substrate, and the terminal electrode is formed on the ceramic substrate by partially exposing it at the non-formed portion, and the heat conducting portion is formed at the non-formed portion of the ceramic substrate.

Also, the electronic component module of the present invention is mounted with an electronic component element at the heat conducting portion of the protection component, and the terminal of the electronic component element is electrically connected to the terminal electrode of the protection component.

According to the protection component of the present invention, it is possible to realize a protection component which is small and strong having a varistor function.

Further, when an electronic component element such as a light-emitting diode is mounted thereon, the electronic component can be mounted a concave portion that is a non-formed portion without the varistor portion and the glass ceramic layer on the ceramic substrate, and therefore, the module can be reduced in thickness.

Also, since there is provided a heat conducting portion on which an electronic component element can be mounted, it is possible to efficiently dissipate heat generated by the component mounted.

Further, the terminal electrode is formed by exposing a part thereof at the non-formed portion on the ceramic substrate, and the surface of the terminal electrode electrically connected to the electronic component element is nearly flush with the mounting surface of the electronic component element, thereby enabling the flip-chip mounting of electronic component elements.

Also, according to the electronic component module of the present invention, the varistor portion of the protection component protects the electronic component element from electrostatic discharge pulses, thereby assuring excellent resistance to electrostatic discharge pulses.

Further, heat generated by an electronic component element such as a light-emitting diode at the heat conducting portion can be efficiently dissipated, which therefore assures excellent heat dissipation and light emission.

Also, since the electronic component element is mounted in a concave portion that is a non-formed portion where the varistor portion and glass ceramic layer are not formed on the ceramic substrate, the module can be reduced in thickness, and it is possible to realize a practical electronic component module reduced in size and thickness.

Further, a flip-chip mounted type of electronic component element is not affected by the silhouette of a metal wire, unlike the one mounted by a wire bonding method using a metal wire, and it is possible to realize an electronic component module which is free from uneven emission of light and capable of assuring higher light emission efficiency.

### BRIEF DESCRIPTION OF THE DRAWINGS

FIG. 1 is a perspective outline view of a protection component in the exemplary embodiment 1 of the present invention.

FIG. 2 is a sectional view along line 2-2 of the protection component in the exemplary embodiment 1.

FIG. 3 is a sectional view along line 3-3 of the protection component in the exemplary embodiment 1.

FIG. 4 is a schematic exploded perspective view of the protection component in the exemplary embodiment 1.

FIG. 5 is a sectional view of an electronic component module in the exemplary embodiment 1.

FIG. 6 is an equivalent circuit diagram of the electronic component module in the exemplary embodiment 1.

FIG. 7 is a schematic exploded perspective view of a protection component in the comparative example.

FIG. 8 is a perspective outline view of a protection component in the comparative example.

FIG. 9 is a sectional view of an electronic component module in the comparative example.

FIG. 10 is a sectional view for describing the method of evaluating the heat dissipation of the electronic component module in the exemplary embodiment 1.

FIG. 11 is a sectional view for describing the method of evaluating the heat dissipation of the electronic component module in the comparative example.

FIG. 12 is a perspective outline view of a protection component in the exemplary embodiment 2 of the present invention.

FIG. 13 is a sectional view along line 13-13 of the electronic component in the exemplary embodiment 2.

FIG. 14 is a sectional view along line 14-14 of the electronic component in the exemplary embodiment 2.

FIG. 15 is a schematic exploded perspective view of the protection component in the exemplary embodiment 2.

FIG. 16 is a sectional view of an electronic component module in the exemplary embodiment 2.

FIG. 17 is a sectional view for describing the method of evaluating the heat dissipation of an electronic component module in the exemplary embodiment 2.

### DETAILED DESCRIPTION OF THE INVENTION

The exemplary embodiments of the present invention will be described in the following with reference to the drawings. In the exemplary embodiments, as an example of an electronic component module, a light-emitting diode module using a light-emitting diode as an electronic component element will be described.

### Exemplary Embodiment 1

A protection component and a light-emitting diode module in the exemplary embodiment 1 of the present invention will be described in the following.

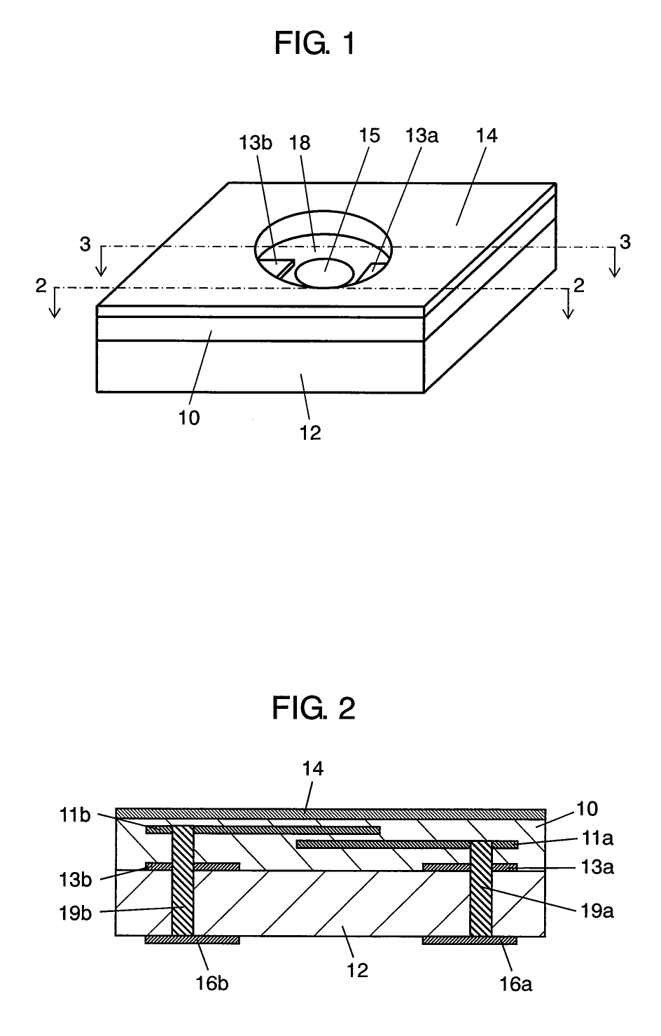

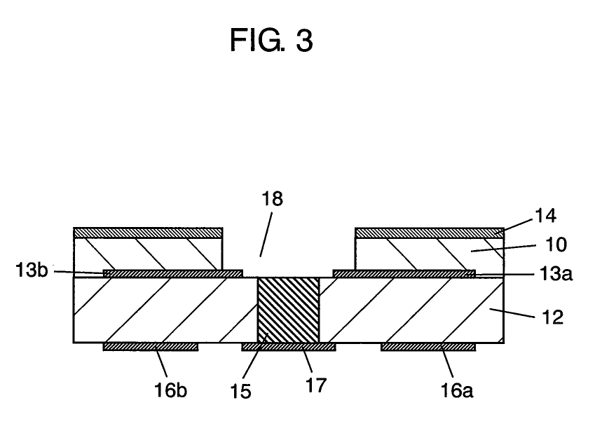

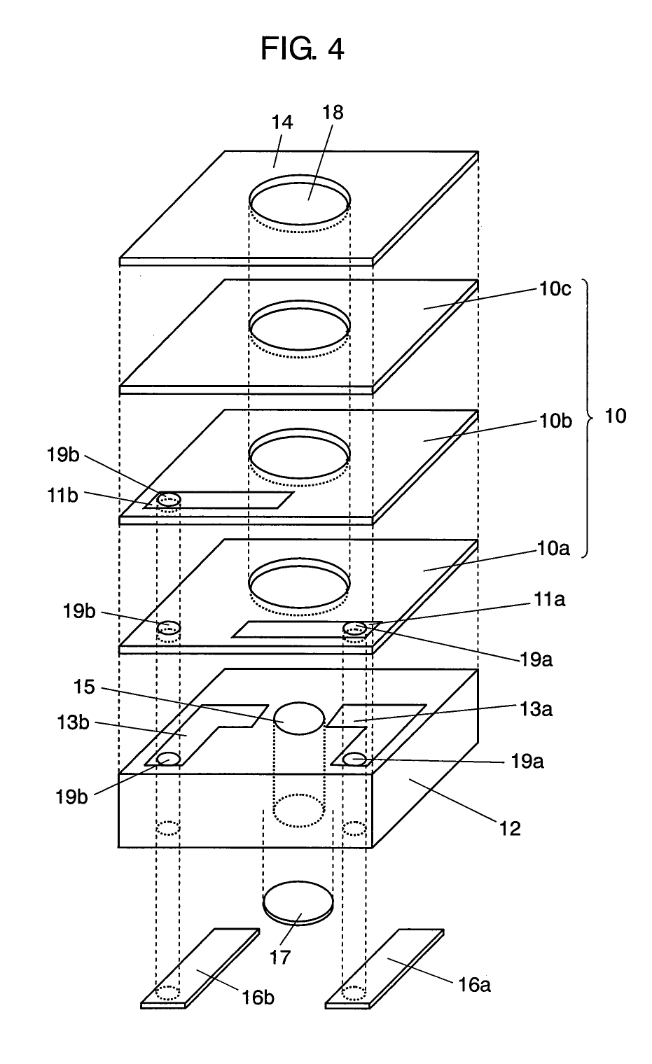

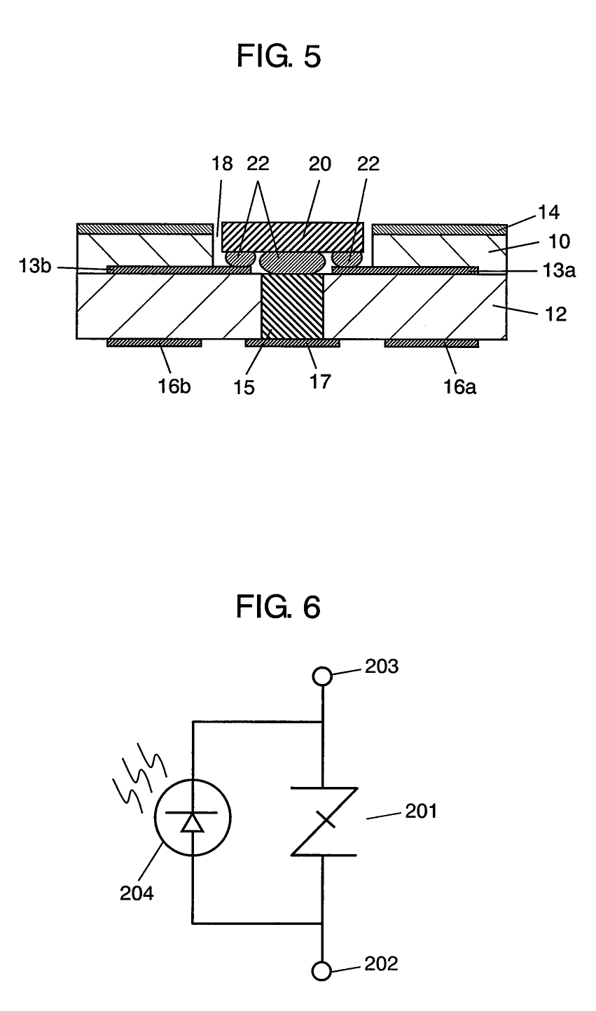

FIG. 1 is a perspective outline view of a protection component in the exemplary embodiment 1 of the present invention. FIG. 2 is a sectional view along 2-2 line of the protection component in the exemplary embodiment. FIG. 3 is a sectional view along 3-3 line of the protection component in the exemplary embodiment. FIG. 4 is a schematic exploded perspective view of the protection component in the exemplary embodiment. FIG. 5 is a sectional view of a light-emitting diode module in the exemplary embodiment. FIG. 6 is an equivalent circuit diagram of the light-emitting diode module in the exemplary embodiment.

As shown in FIGS. 1 to 4, a protection component in the exemplary embodiment includes varistor portion 10 formed by alternately laminating three varistor layers 10a, 10b and 10c, internal electrodes 11a and 11b. Further, there is provided a ceramic sintered body having ceramic substrate 12, varistor portion 10 formed on ceramic substrate 12, and glass ceramic layer 14 laminated thereon. On ceramic substrate 12 of the ceramic sintered body is disposed non-formed portion 18 where varistor portion 10 and glass ceramic layer 14 are not formed. That is, varistor portion 10 and glass ceramic layer 14 are formed on ceramic substrate 12 excluding some non-formed portion 18. A pair of terminal electrodes 13a and 13b are disposed by exposing a part thereof at non-formed portion 18 on ceramic substrate 12 of the ceramic sintered body. A pair of external electrodes 16a and 16b are disposed on a surface opposite to the surface formed with terminal electrodes 13a and 13b of ceramic substrate 12 of the ceramic sintered body. There is provided heat conducting portion 15 vertically penetrating non-formed portion 18 of ceramic substrate 12 of the ceramic sintered body, and further, external heat conducting portion 17 connecting to heat conducting portion 15 at the underside of the ceramic sintered body. Internal electrode 11a is electrically connected to external electrode 16a and terminal electrode 13a via connection via-conductor 19a. Similarly, internal electrode 11b is electrically connected to external electrode 16b and terminal electrode 13b via connection via-conductor 19b. And, in the case of mounting an electronic component element such as a light-emitting diode on a protection component in this exemplary embodiment, heat conducting portion 15 of non-formed portion 18 of ceramic substrate 12 of the ceramic sintered body corresponds to the portion where an electronic component element is mounted. And, terminal electrodes 13a and 13b correspond to the portion of electrical connection to the electronic component element.

Also, as shown in FIG. 5, the light-emitting diode module in the present exemplary embodiment includes light-emitting diode 20 mounted on heat conducting portion 15 of non-formed portion 18 of ceramic substrate 12 of the protection component in the present exemplary embodiment by conductive adhesive 22. One protruding bump terminal of light-emitting diode 20 is electrically connected to terminal electrode 13a, and the other protruding bump terminal is electrically connected to terminal electrode 13b by conductive adhesive 22 for the purpose of flip-chip mounting.

Accordingly, the circuit of the light-emitting diode module in the present exemplary embodiment is an equivalent circuit shown in FIG. 6. In FIG. 6, light-emitting diode 204 is connected in a parallel fashion to external electrodes 202 and 203 of varistor 201 formed by internal electrodes 11a, 11b, and varistor layer 10b described above.

As describe above, the protection component in this exemplary embodiment includes a ceramic sintered body integrated by laminating and sintering varistor 10 and glass ceramic layer 14 on ceramic substrate 12 excluding some non-formed portion 18, and heat conducting portion 15 penetrating the ceramic sintered body is disposed at non-formed portion 18 on ceramic substrate 12.

Also, the light-emitting diode module of the exemplary embodiment is mounted with light-emitting diode 20 on heat conducting portion 15 of non-formed portion 18 of ceramic substrate 12 of the ceramic sintered body.

Accordingly, enhancing the heat conductivity of heat conducting portion 15, it is possible to efficiently dissipate the heat generated by the component mounted.

Also, since external heat conducting portion 17 connecting to heat conducting portion 15 is disposed on the underside of the ceramic sintered body, the adhesion at the connecting portion can be increased when mounted and connected to an external dissipation panel or the like, and it is possible to efficiently dissipate the heat generated by light-emitting diode 20 mounted.

Further, since light-emitting diode 20 is mounted in a concave portion that is non-formed portion 18 where varistor portion 10 and glass ceramic layer 14 are not formed on ceramic substrate 12, it is possible to realize the reduction in thickness of the light-emitting diode module.

Also, because terminal electrodes 13a and 13b are formed on ceramic substrate 12 by exposing a part thereof at non-formed portion 18, the surface of the terminal electrode electrically connected to light-emitting diode 20 is nearly flush with the mounting surface of light-emitting diode 20, thereby enabling the flip-chip mounting of light-emitting diode 20.

With light-emitting diode 20 flip-chip mounted, no silhouette of a metal wire is generated unlike the one mounted by a wire bonding method using a metal wire, and it is possible to realize a light-emitting diode module which is free from uneven emission of light and capable of assuring higher light emission efficiency.

The method of manufacturing a protection component in the exemplary embodiment 1 of the present invention will be described in the following with reference to FIG. 4.

First, a zinc oxide green sheet is produced using ceramic powder having zinc oxide as a main component and also using an organic binder. Also, a glass ceramic green sheet is produced using glass-ceramic powder having alumina and borosilicate glass as a main component also using an organic binder. In this case, these green sheets are about 30 μm in thickness respectively. And, after burning of the green sheets, the zinc oxide green sheet becomes varistor portion 10, while the glass ceramic green sheet becomes glass ceramic layer 14.

As shown in FIG. 4, firstly, a through-hole is formed by using a puncher or the like in the position of connection via-conductor 19a and 19b of the zinc oxide green sheet that becomes varistor layer 10a and 10b, and then the through-hole is filled with silver paste. Subsequently, a conductor layer that becomes internal electrode 11a is formed by a screen printing method using silver paste on the zinc oxide green sheet that becomes varistor layer 11a. A zinc oxide green sheet that becomes varistor layer 10b with conductor layer that becomes internal electrode 11b formed by a screen printing method using silver paste is laminated thereon. Further, a zinc oxide green sheet that becomes varistor layer 10c is laminated thereon to manufacture a laminate body that becomes varistor portion 10. Furthermore, a glass ceramic green sheet that becomes glass ceramic layer 14 is laminated thereon to manufacture a laminate body that becomes varistor portion 10 and glass ceramic layer 14. In this case, the conductor layer that becomes internal electrode 11a, 11b, as shown in FIG. 4, is formed avoiding the position of non-formed portion 18 to be formed later. Also, a through-hole that becomes connection via-conductor 19a is formed in the position where the conductor layer that becomes internal electrode 11a is connected to the conductor layer that becomes terminal electrode 13a. Similarly, a through-hole that becomes connection via-conductor 19b is formed in the position where the conductor layer that becomes internal electrode 11b is connected to the conductor layer that becomes terminal electrode 13b.

Next, a through-hole of about 0.6 mm in diameter that becomes non-formed portion 18 not formed with the varistor portion and glass ceramic layer is formed by using a puncher in such manner that the through-hole goes through varistor portion 10 and glass ceramic layer 14.

On the other hand, as ceramic substrate 12, an alumina substrate provided with through-holes at three positions is used, and the through-holes of the alumina substrate are filled with silver paste. Further, a conductor layer that becomes terminal electrode 13a, 13b is formed on one surface of the alumina substrate by a screen printing method using silver paste. A conductor layer that becomes external heat conducting portion 17 and external electrode 16a, 16b is formed on the other surface of ceramic substrate 12 by a screen printing method using silver paste. The silver paste filled into the three through-holes corresponds to heat conducting portion 15 and connection via-conductor 19a, 19b after burning thereof. And, connection via-conductor 19a is integrated with connection via-conductor 19a of the laminate body after burning thereof, while connection via-conductor 19b is integrated with connection via-conductor 19b of the laminate body after burning thereof.

Next, a laminate body that becomes varistor portion 10 and glass ceramic layer 14 provided with the through-holes is affixed to the alumina substrate having the through-holes filled with silver paste and formed with a conductor layer, thereby making a laminate block. The alumina substrate is about 180 μm in thickness, and the conductor layer is about 2.5 μm in thickness. The silver content of the silver paste used for the heat conducting portion 15 is 85 wt %, and the heat conducting portion 15 is 300 microns in diameter, and the connection via-conductors 19a and 19b are respectively 100 microns in diameter. Also, the printed pattern of conductor layer is such that the multiple shapes are vertically and horizontally arranged so as to be shaped as shown in FIG. 4 after cutting thereof.

Next, the laminate block is heated in the atmosphere for the purpose of de-binder treatment, and after that, it is heated up to 930° C. in the atmosphere for the purpose of burning, thereby making an integrated sintered body. Subsequently, the portions of external electrode 16a, 16b, and terminal electrode 13a, 13b are plated with nickel and gold, and then the sintered body of the laminate block is cut and separated by the specified size into individual pieces, thereby obtaining protection components in the exemplary embodiment shown in FIGS. 1 to 3.

The manufactured protection component in the present exemplary embodiment is about 2.0 mm in length, about 1.25 mm in width, and about 0.3 mm in thickness. Varistor voltage V_{1 mA} between external electrodes 16a and 16b, that is, the voltage in flow of current of 1 mA is 27V.

In the manufacturing method in the present exemplary embodiment described above, as a method of forming external electrodes 16a, 16b, and external heat conducting portion 17, varistor portion 10 and glass ceramic layer 14 are disposed on the alumina substrate, a method of forming them by burning at the same time has been described. However, varistor portion 10 and glass ceramic layer 14, heat conducting portion 15, connection via-conductor 19a and 19b are first disposed as a sintered body. After that, a conductor layer of silver paste that becomes external heat conducting portion 17, external electrode 16a and 16b is formed on one surface of the alumina substrate, which is followed by burning. After that, external heat conducting portion 17, external electrode 16a and 16b are formed. It is allowable to follow such steps. Also, the sintered body in this case is allowable to be multiple pieces vertically and horizontally arranged in the form of blocks or individual pieces, but it is preferable to perform at the stage of sintered body in the form of blocks from the point of productivity.

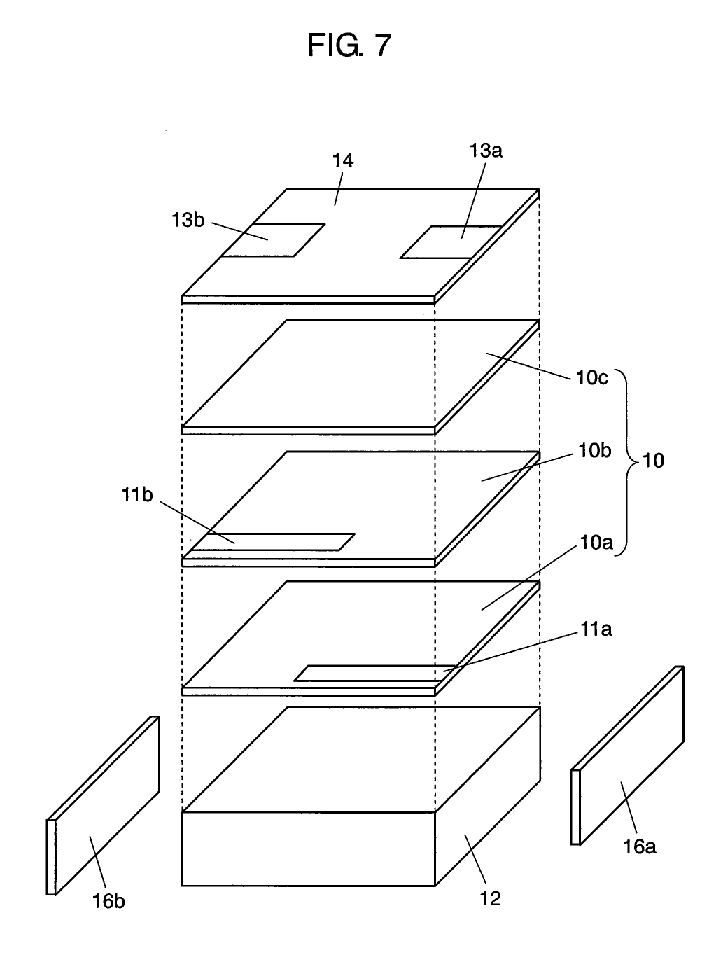

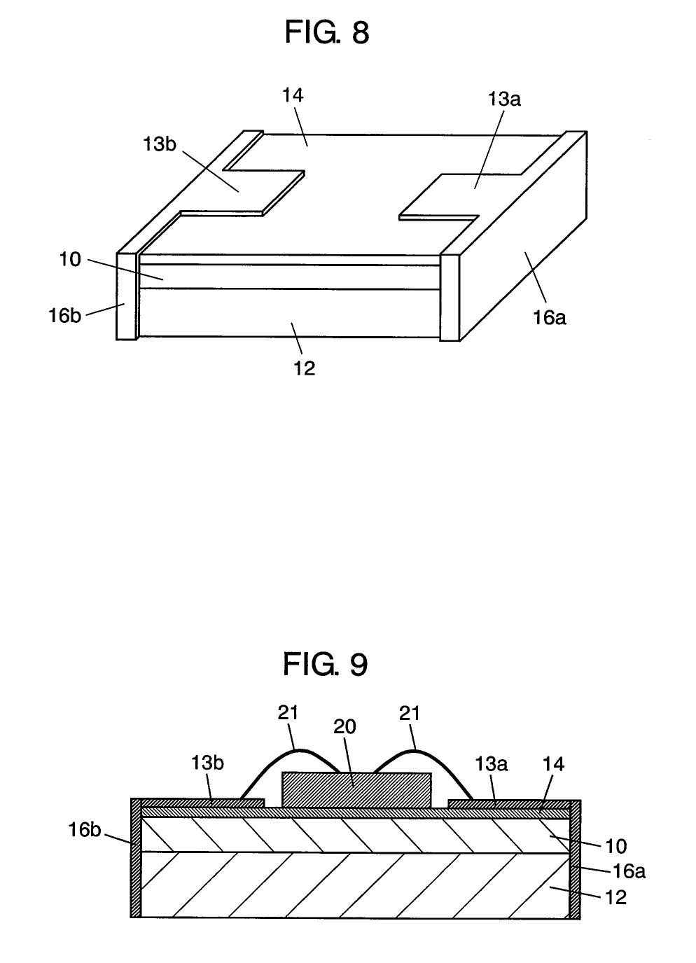

For the purpose of comparison with this exemplary embodiment, an protection component has been manufactured as a comparative example. FIG. 7 is a schematic exploded perspective view of the comparative example. FIG. 8 is an outline perspective view thereof. The protection component of comparative example is different from the protection component in this exemplary embodiment in that non-formed portion 18 not formed with varistor portion 18 and glass ceramic layer 12 is not disposed on ceramic substrate 12. Terminal electrodes 13a and 13b are disposed on the surface of glass ceramic layer 14. Also, heat conducting portion 15 and external heat conducting portion 17 are not disposed. In addition, an external electrode is disposed on the side surface.

The method of manufacturing a light-emitting diode module in one exemplary embodiment of the present invention will be described in the following with reference to FIG. 5.

Light-emitting diode 20 is mounted and connected to the protection component in the present exemplary embodiment described above by a so-called flip-chip mounting method, thereby manufacturing a light-emitting diode module in the present exemplary embodiment shown in FIG. 5. Specifically, blue light-emitting diode 20 having a protruded bump terminal is mounted and connected to heat conducting portion 15 of non-formed portion 18 of ceramic substrate 12 of the protection component in the present exemplary embodiment by a die bonding method using conductive adhesive 22. At the same time, one protruded bump terminal of blue light-emitting diode 20 is connected to terminal electrode 13a by using conductive adhesive 22, and the other protruded bump terminal of blue light-emitting diode 20 is connected to terminal electrode 13b by using conductive adhesive 22. After that, blue light-emitting diode 20 is covered with resin (not shown), thereby making a light-emitting diode module shown in FIG. 5. In FIG. 5, conductive adhesive 22 on die-bonded heat conducting portion 15 is an example such that it is electrically disconnected from both of terminal electrodes 13a and 13b, but conductive adhesive 22 on heat conducting portion 15 is allowable to be electrically connected to a terminal electrode that becomes the ground terminal of any one of terminal electrodes 13a and 13b.

As shown in FIG. 5, the light-emitting diode module in this exemplary embodiment includes light-emitting diode 20 flip-chip-mounted in the concave portion that corresponds to non-formed portion 18 where varistor portion 10 and glass ceramic layer 14 are not formed on ceramic substrate 12. Accordingly, the light-emitting diode 20 will not excessively protrude and it is possible to realize the reduction in thickness of the module. Also, unlike a wire bonding method using a metal wire, no silhouette of the metal wire is generated, and it is possible to realize a light-emitting diode module which is free from uneven emission of light and capable of assuring higher light emission efficiency.

Further, for the comparison with the present exemplary embodiment, a light-emitting diode module has been manufactured according to the following procedure by using the protection component of the comparative example mentioned above. FIG. 9 is a sectional view of an electronic component module in the comparative example. In FIG. 9, first, blue light-emitting diode 20 is mounted on glass ceramic layer 14 of the protection component of the comparative example by a die bonding method using conductive adhesive. After that, one terminal of blue light-emitting diode 20 is connected by a wire bonding method to terminal electrode 13a with use of metal wire 21. Subsequently, the other terminal of blue light-emitting diode 20 is connected to terminal electrode 13b with use of metal wire 21. After that, blue light-emitting diode 20 is covered with resin (not shown). As shown in FIG. 9, in the light-emitting diode module of comparative example, light-emitting diode 20 is greatly protruded, and it is harder to reduce the thickness of the module as compared with the light-emitting diode module in the present exemplary embodiment.

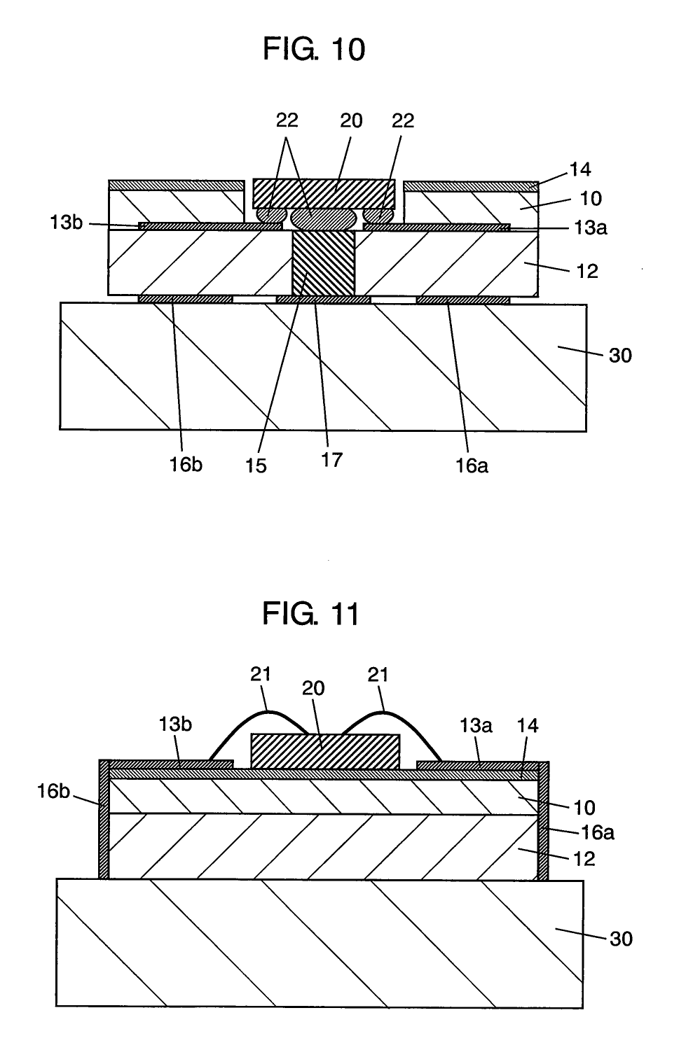

And, the light-emitting diode module in the present exemplary embodiment and the light-emitting diode module of the comparative example are evaluated in the following with respect to heat dissipation. As for each of the light-emitting diode modules, the light-emitting diode module in the present exemplary embodiment as shown in FIG. 10 and the comparative example as shown in FIG. 11 are respectively mounted on dissipation panel 30. Although it is not shown, on the surface of dissipation panel 30, at least a surface other than the area at the grounding side out of the surfaces where external electrodes 16a and 16b come in contact is insulated and there is provided wiring for power supply.

And, 1 W power is applied to each blue light-emitting diode 20 to let the diode emit light, and the power is continuously supplied until saturation of temperature of blue light-emitting diode 20. At the time, the temperature of the blue light-emitting diode 20 is about 100° C. in the case of the light emitting diode module of the comparative example, while it is about 80° C. in the case of the light-emitting diode module in the present exemplary embodiment.

As described above, the light-emitting diode module in the present exemplary embodiment is more excellent in heat dissipation as compared with the light-emitting diode module of the comparative example.

Also, in the measurement of light intensity at the time of temperature saturation of blue light-emitting diode 20, when the light intensity ratio of the light-emitting diode module of the comparative example is 100, the light intensity ratio of the light-emitting diode module in the present exemplary embodiment is about 125. From this result, it is clear that the light-emitting diode module in the present exemplary embodiment is excellent in heat dissipation and capable of preventing the light-emitting diode from lowering in light emission efficiency.

Further, in the comparative example prepared by a wire bonding method using a metal wire, a silhouette of the metal wire is generated, while in the case of the light-emitting diode module in the present exemplary embodiment, no silhouette of the metal wire is generated and the module obtained is free from uneven emission of light.

Also, in the protection component and light-emitting diode module in the present exemplary embodiment, an external terminal is disposed on a surface opposite to the terminal electrode side, and therefore, the area of mounting onto the wiring board or the like can be decreased as compared with the protection component and light-emitting diode module of the comparative example.

Further, in the protection component of the comparative example, an external terminal is disposed on the side surface, and the external terminal has to be disposed after cutting the element into individual pieces for the convenience of manufacture Accordingly, it is necessary to perform the plating of external terminal 16a and 16b, and mounting of the light-emitting diode 20 in the form of individual pieces. On the other hand, in the case of protection component in the present exemplary embodiment, all of the internal electrode 11a and 11b, external electrode 16a and 16b, and terminal electrode 13a and 13b can be formed by a screen printing method, and therefore, the external electrode 16a and 16b are formed before cutting the element into individual pieces. Accordingly, it is possible to perform the plating of external electrodes 16a and 16b before cutting the element into individual pieces and to lower the cost as a result of simplifying the manufacturing process.

In addition, it is possible to mount an electronic component element such as a light-emitting diode before cutting the element into individual pieces and to manufacture the light-emitting diode module by cutting the element into individual pieces. As a result, the method of manufacturing light-emitting diode modules can be simplified and the cost can be lowered.

### Exemplary Embodiment 2

A protection component and light-emitting diode module in the exemplary embodiment 2 of the present invention will be described in the following.

The point of difference between the exemplary embodiment 2 and the exemplary embodiment 1 is such that in the exemplary embodiment 1, external electrodes 16a, 16b are formed on the surface where terminal electrodes 13a, 13b of ceramic substrate 12 are formed, while in the exemplary embodiment 2, external electrodes 16a, 16b are formed on the side surface of varistor portion 10 and ceramic substrate 12.

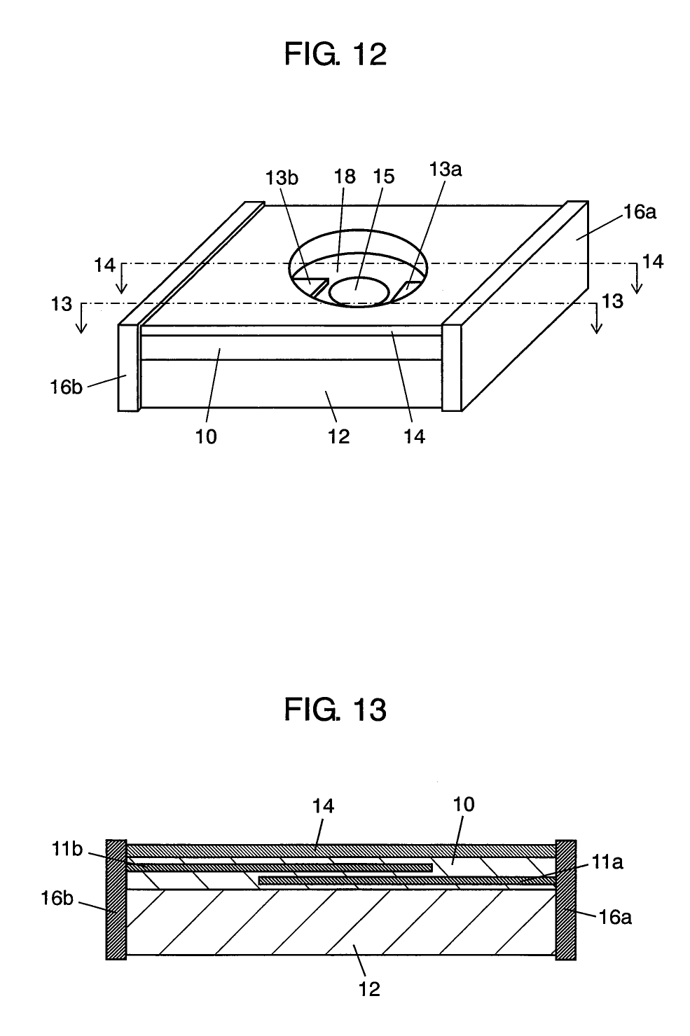

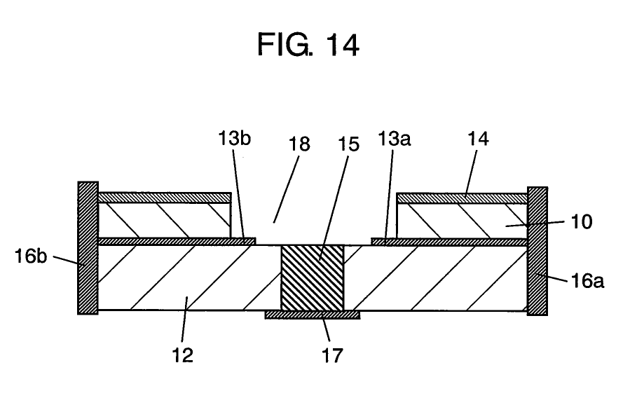

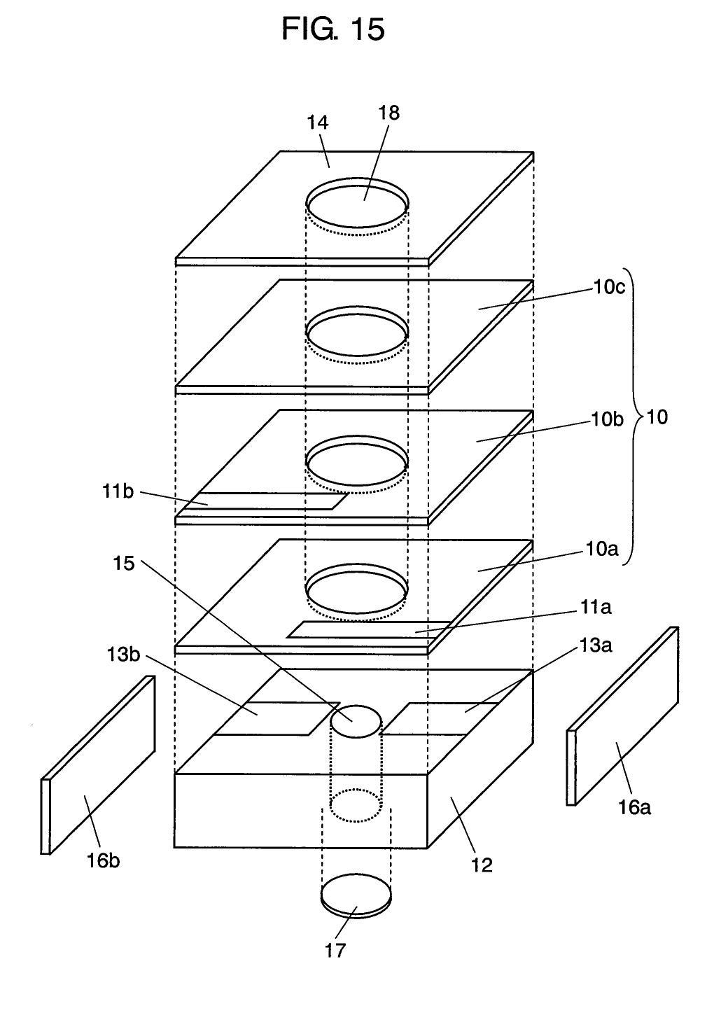

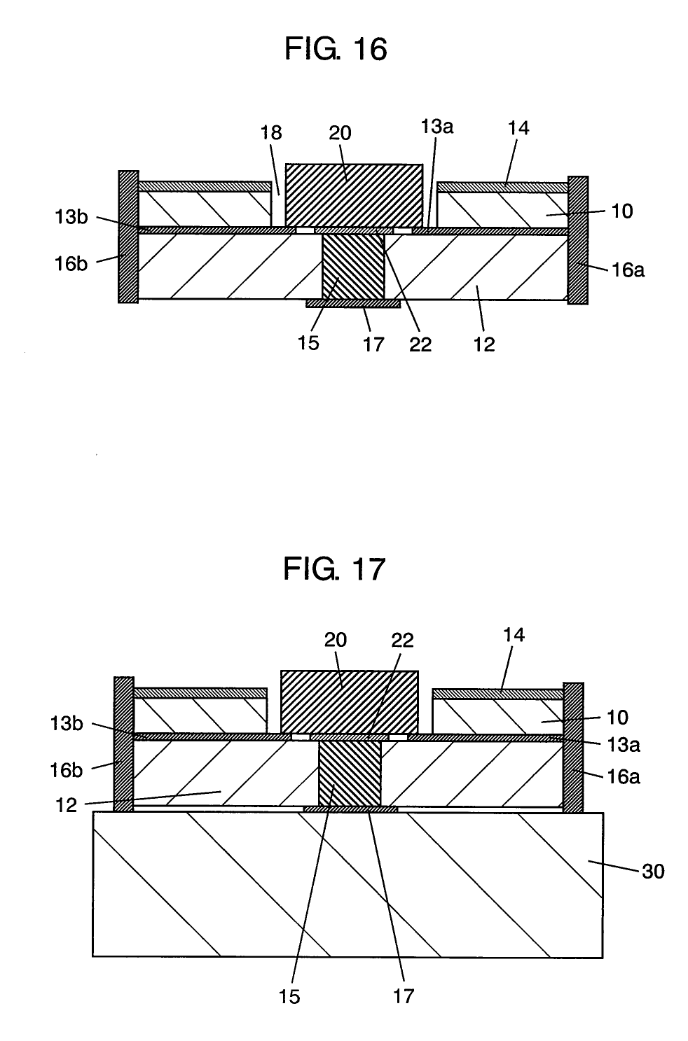

FIG. 12 is an outline perspective view of a protection component in the present exemplary embodiment. FIG. 13 is a sectional view along 13-13 line in FIG. 12 of the protection component in the present exemplary embodiment. FIG. 14 is a sectional view along 14-14 line in FIG. 12 of the protection component in the present exemplary embodiment. FIG. 15 is a schematic exploded perspective view of the protection component in the present exemplary embodiment. FIG. 16 is a sectional view of the light-emitting diode module in the present exemplary embodiment.

As shown in FIGS. 12 to 15, in the protection component in the present exemplary embodiment, same as in the exemplary embodiment 1, varistor portion 10 is formed by alternately laminating varistor layers 10a, 10b, and 10c, internal electrodes 11a and 11b. And, the protection component in the present exemplary embodiment includes a ceramic sintered body provided with ceramic substrate 12, varistor portion 10 formed on ceramic substrate 12 excluding some non-formed portion 18, and glass ceramic layer 14 further laminated thereon. A pair of terminal electrodes 13a and 13b are disposed on ceramic substrate 12 of the ceramic sintered body by exposing a part thereof at non-formed portion 18. The ceramic sintered body is provided with a pair of external electrodes 16b and 16b connected to internal electrodes 11a, 11b and terminal electrodes 13a, 13b. In the present exemplary embodiment, external electrodes 16a and 16b are disposed on the side surface of the ceramic sintered body. There is provided heat conducting portion 15 vertically penetrating non-formed portion 18 of ceramic substrate 12 of the ceramic sintered body, and further external heat conducting portion 17 connected to heat conducting portion 15 at the underside of the ceramic sintered body. Internal electrode 11a and terminal electrode 13a are electrically connected to external electrode 16a by drawing it out to one end of the ceramic sintered body. Similarly, internal electrode lib and terminal electrode 13b are electrically connected to external electrode 16b by drawing it out to the other end of the ceramic sintered body. And, when an electronic component element such as light-emitting diode is mounted on the protection component in the present exemplary embodiment, heat conducting portion 15 of non-formed portion 18 of ceramic substrate 12 of the ceramic sintered body corresponds to the surface where the electronic component element is mounted. Terminal electrodes 13a and 13b correspond to the electrical connections to the electronic component element.

Also, as shown in FIG. 16, the light-emitting diode module in the present exemplary embodiment is mounted with light-emitting diode 20 on heat conducting portion 15 of non-formed portion 18 of ceramic substrate 12 of the protection component in the present exemplary embodiment. One protruded bump terminal of light-emitting diode 20 is electrically connected to terminal electrode 13a, and the other protruded bump terminal is electrically connected to terminal electrode 13b, making a flip-flop mounting configuration.

And, the circuit of the light-emitting diode module in the present exemplary embodiment is an equivalent circuit shown in FIG. 6, the same as in the exemplary embodiment 1.

Thus, the protection component in this exemplary embodiment includes a ceramic sintered body integrated by laminating and sintering varistor portion 10 and glass ceramic layer 14 on ceramic substrate 12 excluding some non-formed portion 18, and heat conducting portion 15 penetrating the ceramic sintered body is disposed at non-formed portion 18 of ceramic substrate 12.

Also, the light-emitting diode module in this exemplary embodiment is mounted with light-emitting diode 20 on heat conducting portion 15 of non-formed portion 18 of ceramic substrate 12 of the ceramic sintered body.

Accordingly, enhancing the heat conductivity of heat conducting portion 15, it is possible to efficiently dissipate the heat generated by components mounted.

Also, since protruded external heat conducting portion 17 connected to heat conducting portion 15 is disposed on the underside of the ceramic sintered body, the adhesion at the connecting portion can be increased when mounted and connected to an external dissipation panel or the like, and it is possible to efficiently dissipate the heat generated by electronic component elements mounted.

Further, since light-emitting diode 20 is mounted in a concave portion that is non-formed portion 18 where varistor portion 10 and glass ceramic layer 14 are not formed on ceramic substrate 12, it is possible to realize the reduction in thickness of the light-emitting diode module.

Because terminal electrodes 13a and 13b are formed on ceramic substrate 12 by exposing a part thereof at non-formed portion 18, the surface of the terminal electrode electrically connected to light-emitting diode 20 is nearly flush with the mounting surface of light-emitting diode 20, thereby enabling the flip-chip mounting of light-emitting diode 20.

With light-emitting diode 20 flip-chip mounted, no silhouette of a metal wire is generated unlike the one mounted by a wire bonding method using a metal wire, and it is possible to realize a light-emitting diode module which is free from uneven emission of light and capable of assuring higher light emission efficiency.

The method of manufacturing a protection component in the present exemplary embodiment will be described in the following with reference to FIG. 15.

First, a zinc oxide green sheet is produced using ceramic powder having zinc oxide as a main component and also using an organic binder. Also, a glass ceramic green sheet is produced using glass ceramic powder having alumina and borosilicate glass as a main component and also using an organic binder. In this case, these green sheets are about 30 μm in thickness respectively. And, after burning of the green sheets, the zinc oxide green sheet becomes varistor portion 10, while the glass ceramic green sheet becomes glass ceramic layer 14.

As shown in FIG. 15, conductor layer that becomes internal electrode 11a is formed by a screen printing method using silver paste on the zinc oxide green sheet that becomes varistor layer 10a. The zinc oxide green sheet that becomes varistor layer 10b with conductor layer that becomes internal electrode 11b formed by a screen printing method using silver paste is laminated thereon. Further, the zinc oxide green sheet that becomes varistor layer 10c is laminated thereon to manufacture a laminate body that becomes varistor portion 10. Furthermore, the glass ceramic green sheet that becomes glass ceramic layer 14 is laminated thereon to manufacture a laminate body that becomes varistor portion 10 and glass ceramic layer 14. In this case, the conductor layer that becomes internal electrode 11a, 11b, as shown in FIG. 15, is formed avoiding the position of non-formed portion 18 to be formed later.

Next, a through-hole of 0.6 mm in diameter that becomes non-formed portion 18 not formed with the varistor portion 10 and glass ceramic layer 14 is formed by using a puncher in such manner that the through-hole goes through varistor portion 10 and glass ceramic layer 14.

On the other hand, as ceramic substrate 12, an alumina substrate provided with through-holes at predetermined positions is used, and the through-holes of the alumina substrate are filled with silver paste. Further, a conductor layer that becomes terminal electrode 13a, 13b is formed on one surface of the alumina substrate by a screen printing method using silver paste. Also, a conductor layer that becomes external heat conducting portion 17 is formed on the other surface of ceramic substrate 12 by a screen printing method using silver paste. The silver paste filled into the through-holes corresponds to heat conducting portion 15 after burning thereof.

Next, a laminate body that becomes varistor portion 10 and glass ceramic layer 14 provided with the through-holes is affixed to the alumina substrate having the through-holes filled with silver paste and formed with a conductor layer, thereby making a laminate block. The alumina substrate is about 180 μm in thickness, and the conductor layer is about 2.5 μm in thickness. The silver content of the silver paste used for the heat conducting portion is 85 wt %, and the heat conducting portion is 300 microns in diameter. Also, the printed pattern of conductor layer is such that the multiple shapes are vertically and horizontally arranged so as to be shaped as shown in FIG. 15 after cutting thereof.

Next, the laminate block is heated in the atmosphere for the purpose of de-binder treatment, and after that, it is heated up to 930° C. in the atmosphere for the purpose of burning, thereby making an integrated sintered body. The sintered body of the laminate block is cut and separated by the specified size into individual pieces. Further, silver paste is applied to the end surface of the sintered body and heated at 900° C. to form external electrode 16a and 16b. Subsequently, the external electrode 16a and 16b portions and terminal electrode 13a and 13b portions are plated with nickel and gold, thereby obtaining protection components in the present exemplary embodiment shown in FIGS. 12 to 14.

The manufactured protection component in the present exemplary embodiment is about 2.0 mm in length, about 1.25 mm in width, and about 0.3 mm in thickness. And, varistor voltage V_{1mA}between external electrodes 16a and 16b, that is, the voltage in flow of current 1 mA is 27V.

In the manufacturing method in the present exemplary embodiment described above, as a method of forming heat conducting portion 15 and external heat conducting portion 17, varistor portion 10 and glass ceramic layer 14 are disposed on the alumina substrate, a method of forming them by burning at the same time has been described. However, varistor portion 10 and glass ceramic layer 14 are first disposed on the alumina substrate as a sintered body. After that, the through-hole is filled with silver paste that becomes heat conducting portion 15, and a conductor layer of silver paste that becomes external heat conducting portion 17 is formed on one surface of the alumina substrate, which is followed by burning. After that, heat conducting portion 15 and external heat conducting portion 17 are formed. It is allowable to follow such steps.

Also, the sintered body in this case is allowable to be multiple pieces vertically and horizontally arranged in the form of blocks or individual pieces, but it is preferable to perform at the stage of sintered body in the form of blocks from the point of productivity.

Further, for the purpose of comparison with this exemplary embodiment, a protection component has been manufactured as a comparative example, as shown in FIGS. 7 and 8, same as the exemplary embodiment 1. The protection component of comparative example is different from the protection component in this exemplary embodiment in that non-formed portion 18 not formed with varistor portion and glass ceramic layer is not disposed on ceramic substrate 12. Terminal electrodes 13a and 13b are disposed on the surface of glass ceramic layer 14. Also, heat conducting portion 15 and external heat conducting portion 17 are not disposed.

The method of manufacturing a light-emitting diode module in the present exemplary embodiment will be described in the following with reference to FIG. 16.

Light-emitting diode 20 is mounted and connected to the protection component in the present exemplary embodiment described above by a so-called flip-chip mounting method, thereby manufacturing a light-emitting diode module in the present exemplary embodiment shown in FIG. 16. Specifically, blue light-emitting diode 20 having a protruded bump terminal is mounted and connected to heat conducting portion 15 of non-formed portion 18 of ceramic substrate 12 of the protection component in the present exemplary embodiment by a die bonding method using conductive adhesive 22. One protruded bump terminal of blue light-emitting diode 20 is connected to terminal electrode 13a by using conductive adhesive 22, and the other protruded bump terminal of blue light-emitting diode 20 is connected to terminal electrode 13b by using conductive adhesive 22. After that, blue light-emitting diode 20 is covered with resin (not shown), thereby making a light-emitting diode module shown in FIG. 16.

In FIG. 16, conductive adhesive 22 on die-bonded heat conducting portion 15 is an example such that it is electrically disconnected from both of terminal electrodes 13a and 13b. However, conductive adhesive 22 on heat conducting portion 15 is allowable to be electrically connected to a terminal electrode that becomes the ground terminal of any one of terminal electrodes 13a and 13b.

As shown in FIG. 16, the light-emitting diode module in this exemplary embodiment includes light-emitting diode 20 flip-chip-mounted in the concave portion that corresponds to non-formed portion 18 not formed with varistor portion 10 and glass ceramic layer 14 on ceramic substrate 12. Accordingly, the light-emitting diode will not excessively protrude and it is possible to realize the reduction in thickness of the module.

Also, unlike a wire bonding method using a metal wire, no silhouette of the metal wire is generated, and it is possible to realize a light-emitting diode module which is free from uneven emission of light and capable of assuring higher light emission efficiency.

Further, for the purpose of comparison, a light-emitting diode module has been manufactured according to the following procedure by using the protection component of the comparative example mentioned above. In FIGS. 7 to 9, blue light-emitting diode 20 is mounted on glass ceramic layer 14 of the protection component of the comparative example by a die bonding method using conductive adhesive (not shown). Subsequently, one terminal of blue light-emitting diode 20 is connected by a wire bonding method to terminal electrode 13a with use of metal wire 21. And, the other terminal of blue light-emitting diode 20 is connected to terminal electrode 13b with use of metal wire 21. After that, blue light-emitting diode 20 is covered with resin (not shown). As shown in FIG. 9, in the light-emitting diode module of comparative example, the light-emitting diode is greatly protruded, and it is harder to reduce the thickness of the module as compared with the light-emitting diode module in the present exemplary embodiment shown in FIG. 16.

The light-emitting diode module in the present exemplary embodiment and the light-emitting diode module of the comparative example are evaluated in the following with respect to heat dissipation. Each of the light-emitting diode modules, as shown in FIG. 17 (not shown for the comparative example), is mounted on heat dissipation panel 30, and 1 W power is applied to each blue light-emitting diode to let the diode emit light. The power is continuously applied until temperature saturation of the blue light-emitting diode. The temperature of the blue light-emitting diode module of the comparative example is then about 100° C., while that of the light-emitting diode in the present exemplary embodiment is about 80° C. As described above, it is clear that the light-emitting diode module in the present exemplary embodiment is more excellent in heat dissipation as compared with the light-emitting diode module of the comparative example.

Also, in the measurement of light intensity at the time of temperature saturation of the blue light-emitting diode, when the light intensity ratio of the light-emitting diode module of the comparative example is 100, the light intensity ratio of the light-emitting diode module in the present exemplary embodiment is about 125. From this result, it is clear that the light-emitting diode module in the present exemplary embodiment is excellent in heat dissipation and capable of preventing the light-emitting diode from lowering in light emission efficiency.

Further, in the comparative example prepared by a wire bonding method using a metal wire, a silhouette of the metal wire is generated, while in the case of the light-emitting diode module in the present exemplary embodiment, no silhouette of the metal wire is generated and the module obtained is free from uneven emission of light.

As described above, the protection component of the present invention is a small and strong electronic component having a varistor function.

Further, when mounting an electronic component element such as a light-emitting diode, the electronic component element can be mounted in a concave portion that is a non-formed portion where the varistor portion and glass ceramic layer are not formed on the ceramic substrate, and consequently, it is possible to reduce the thickness of the module.

Also, there is provided a heat conducting portion, and an electronic component element can be mounted thereon, and it is possible to efficiently dissipate the heat generated by the component mounted.

Also, in the electronic component module of the present invention, the electronic component element such as a light-emitting diode is protected by a varistor portion from electrostatic discharge pulses, which therefore ensures excellent resistance to electrostatic discharge pulses.

Further, the heat generated by the electronic component element is efficiently dissipated at the heat conducting portion, and the module ensures excellent heat dissipation and light emission efficiency.

Also, since the electronic component element is mounted in a concave portion that is a non-formed portion where the varistor portion and glass ceramic layer are not formed on the ceramic substrate, the module can be reduced in thickness, and it is possible to obtain a small, thin, and practical electronic component module.

Further, unlike a wire bonding method using a metal wire, no silhouette of the metal wire is generated. As a result, the electronic component module obtained is free from uneven emission of light and higher in light emission efficiency.

In addition, using a white substrate such as an alumina substrate as the ceramic substrate, for example, when mounting a light-emitting diode, it is possible to enhance the emission efficiency of the light-emitting diode because the area around the light-emitting diode is white and high in reflection factor.

What is claimed is:

1) An electrostatic discharge protection component comprising: a ceramic sintered body having a ceramic substrate, a varistor portion formed by alternately laminating a varistor layer and an internal electrode on the ceramic substrate, and a glass ceramic layer formed on the varistor portion, a pair of terminal electrodes disposed on the ceramic sintered body, a pair of external electrodes connected to the internal electrode and the terminal electrodes, and a heat conducting portion penetrating the ceramic sintered body, wherein the varistor portion and the glass ceramic layer are formed excluding some non-formed portion of the ceramic substrate, and the terminal electrode is formed on the ceramic substrate by partially exposing it at the non-formed portion, and the heat conducting portion is formed at the non-formed portion of the ceramic substrate.

2) The electrostatic discharge protection component of claim 1, wherein the external electrode is formed on a surface opposite to a surface where the terminal electrode is formed on the ceramic substrate.

3) The electrostatic discharge protection component of claim 1, wherein an external heat conducting portion connected to the heat conducting portion is disposed on a surface opposite to a surface where the terminal electrode of the ceramic sintered body is formed.

4) An electronic component module wherein an electronic component element is mounted on the heat conducting portion of the electrostatic discharge protection component of claim 1, and a terminal of the electronic component element is electrically connected to the terminal electrode of the electrostatic discharge protection component.

5) The electronic component module of claim 4, wherein the electronic component element is mounted in a flip-chip fashion.

6) The electronic component module of claim 4, wherein the electronic component element is a light-emitting diode.
